(19) United States
(12) Patent Application Publication
(10) Pub. No.: US 2010/0263323 A1
(43) Pub. Date: Oct. 21, 2010

(54) Method and materials for decorative glowing tile installations with optional inserts

(76) Inventors: Christian Trinidade, Chelmsford, MA (US); Harold Weissman, Lexington, MA (US)

Correspondence Address: FRANCIS H. KIRKPATRICK;KIRKPATENT CONSULTING, 37 CLOVER HILL DR., CHELMSFORD, MA, 01824-2611, US

(21) Appl. No.: 12/217,827

(22) Filed: Jul. 9, 2008

Related U.S. Application Data
(60) Provisional application No. 60/958,769, filed on Jul. 9, 2007.
(60) Provisional application No. 61/001,527, filed on Nov. 3, 2007.
(60) Provisional application No. 61/068,516, filed on Mar. 8, 2008.

(51) Int. Cl. E04F 13/21; B32B 3/10; C04B 33/32; B29C 44/34; B23K 26/00; B26D 5/12

(52) U.S. Cl. 52/747.11; 428/210; 264/601; 264/44; 219/121.72; 83/53

(57) ABSTRACT

A decorative tile or set of tiles is provided for use in swimming pools, bathrooms, kitchens and the like. Tiles are manufactured to have a glazed front surface of a first color, and one or more openings in said front surface in a pattern. Decorative grouts are used to fill the openings in the glazed tiles to produce the desired decorative effect. In use, the tiles are held in place by a conventional bedding grout, and finished with a finishing grout. The openings are preferably holes through the tile, having openings at front and back. In a preferred embodiment, some or all of the decorative grouting that is used to fill the openings is a phosphorescent grout that accumulates solar or other light energy, and glows in the dark.

### PRIORITY

This application claims the benefit of the priority of U.S. provisional patent applications 60/958,769, filed Jul. 9, 2007; 61/001527, filed Nov. 3, 2007; and 61/068516, filed Mar. 8, 2008; and each of these applications is incorporated herein by reference in its entirety.

### BACKGROUND

One of the difficult areas of ceramic tile manufacturing is the provision of colors or other decorative features that match the customer's exact taste, or coordinate properly with other colors that may be present in a site where tile is installed. While such problems are also found in other decorative materials, ceramic tile is heavy and bulky, and so provision of both a wide palette of colors and a variety of designs presents difficult logistical problems.

A solution to this problem has been attempted by providing painted tile, which can easily be customized. However, painted designs lack the durability that is a desirable feature of ceramics. Another traditional solution is to form a mosaic, creating the desired decorative pattern by installation of a large number of small tiles. Such installations can be durable if done properly, but are very labor intensive and correspondingly expensive. A compromise solution is to make ceramic tiles with depressions in the exposed surface, or holes, into which decorative structures, typically themselves ceramics, can be adhered.

Examples of such approaches to the problem can be found in the art, for example in the abstracts, available from the European Patent Office's web site (http://ep.espacenet.com), of Sueyoshi Nariyuki, JP10119499, formation of patterns on tiles by sandblasting, filling and firing or refiring; Garcia Ten Javier et al, ES2174695, use of magnets and magnetic fluids to shape tiles; Tosi Sergio, EP1083062, forming an elastomeric form for impressing designs on an unfired tile's surface; Downing A. Charles, GB189717004, use of plaster of Paris and spherical beads to make ornamental tiles; Morandi Marco, IT1262800, use of clay and borosilicate to control shrinking in inlays in tiles during firing; Tamakoshi Toshio et al, JP1316260, use of thin layers of ceramic-forming materials with pattern cutouts to form a mold into which a differently colored ceramic is placed, before firing; and Osawa Keizo et al, JP9134110, making a hologram suitable for use underwater by placing the hologram between a ceramic tile base plate, and a glass plate, and bonding the assembly with clear epoxy. Kakamu et al., U.S. Pat. No. 5,670,228, make patterned unglazed tiles by pressing together shapes of unfired colored material, forming tile shapes, and firing.

A partial approach to this problem has been provided by Winberry (U.S. 2004/0221530), who cuts patterns in thin laminae of metal or ceramic with lasers or water jets, glues the patterned laminae to backing plates, creating a multi-piece assembly, and fills the cut parts of the pattern with a decorative grout at the time of final installation. Because the design is engineered for the option to receive decorative grouts during installation, the thin laminae as illustrated do not appear to be likely to maintain the decorative materials in place during transport, and no robust mechanism for maintaining the decorations in place is provided.

More recently, improved materials for use as grout in ceramic tile installations have been described, particularly in Rooshenas, U.S. Pat. No. 6,881,768and U.S. 2005/0120671. These grouts are based on polymerizable organic fillers containing decorative materials, such as color coated sands, and optionally materials providing other optical effects, including luminescence. The key feature of the invention appears to be the inclusion of a water-repellant component in the mixture. The grout is used as a finishing grout, to fill spaces between tiles after their installation in a bedding grout.

None of these approaches is entirely satisfactory for the simple, flexible production of decorative ceramic tiles, having decorative patterns formed with openings and filled with grout during manufacture, prior to installation in openings in the tiles by colored or luminous grout, and their installation within a contrasting and typically different finishing grout.

### DESCRIPTION OF THE INVENTION

Simple approaches to the problem of customization of tile design and simplification of providing custom installations have been developed, which allow customization of installations while simplifying manufacturing and decreasing the required inventory.

In a first embodiment, tiles are made by conventional casting and firing methods. Openings in the glazed front face of the tile, preferably comprising regions that penetrate the entire thickness of the tile, form a decorative pattern. Such through holes are created in a tile in decorative patterns by cutting with a water jet, or by use of other cutting methods, such as lasers or machining. The openings are filled with a decorative grout material, which is preferably applied before installation of the tile. Any partial thickness regions, if present, preferably have a textured upper surface (surface towards the face of the tile), providing a rough surface that increases adherence of a decorative grout to the surface of the partial thickness region.

The decorative grout may be of different colors in different openings in the tile, and/or in different tiles in the installation. Moreover, in one version of this approach, a tile installation can be made in which the patterns in the tile glow in the dark. In another version, the decorative tiles are highly reflective. The tiles are affixed to a surface by a bedding grout. The bedding grout is typically not visible in the finished installation. After attaching tiles with bedding grout, a finishing grout is typically applied to fill spaces between tiles. The finishing grout may be of any color, but often contrasts with the decorative grout that was placed in the tile openings during manufacture.

A preferred decorative grout is one that is phosphorescent. A dictionary definition of phosphorescence, for example in “Webster's Ninth New Collegiate Dictionary” (Merriam-Webster, 1986) is: “luminescence that is caused by the absorption of radiations and continues for a noticeable period of time after these radiations have stopped.” In contrast, fluorescence is the “emission of radiation usually as visible light resulting from and occurring only during the absorption of radiation from some other source.” (op. cit.) Luminescence is “an emission of light that is not ascribed directly to incandescence and therefore occurs at low temperature, and is produced by physiological processes, by chemical action, by friction or by electrical action.” (op. cit.) However, “luminous” is often used more broadly, and simply means “glowing”.

In one aspect of the invention, a method of forming a decorative tile installation comprises the steps of providing one or more tiles having a first surface color and a decorative patterns of openings that are formed in the tiles by the manufacturer; filling the openings with at least one color of decorative grout at manufacture, wherein at least one color of decorative grout is different from said first surface color of the tiles; and affixing said tiles to a bedding grout and then filling the tile lines between the individual tiles with a finishing grout, the finishing grout having a color of the applicator's choice. In this and all aspects of the invention described herein, the “color” of a grout can include both conventional coloration, and also provision of optical effects such as phosphorescence or reflectivity, or a combination thereof.

In another aspect of the invention, openings in tiles are filled with a decorative grout before installation. In a preferred embodiment, a through opening in the decorative surface of the tile is temporarily closed by reversibly attaching a barrier across the opening, for example an adhering tape. Preferably, the closure is applied to the face of the tile. A layer of decorative grout is applied into the opening, typically from the back of the tile, and allowed to at least partially cure. The decorative layer does not necessarily completely fill the through hole. After sufficient curing for stability (but not necessarily complete curing), the remainder of the hole is filled from the back to provide a flush back surface. A non-decorative grout may be used to fill the remainder of the hole, or any convenient material can be used for the purpose. The barrier is removed at any time after the first decorative grout has cured sufficiently to be stable. The resulting surface of decorative grout is smooth, essentially planar, and flush with the face of said tile.

In any aspect of the invention, there may be more than one color of decorative grout, or more than one surface color in the tiles provided. In any aspect of the invention, the decorative openings in the tile may be made by one or more processes selected from cutting with water-jet, laser, or mechanical device, including machining; or casting, molding, die-cutting of greenware, and provision of sacrificial elements that burn away during firing.

In another aspect, the invention comprises a decorative tile installation, wherein the tile installation has been formed by applying one or more decorative grouts to fill openings in glazed ceramic tiles, before affixing the ceramic tiles to a bedding grout layer, wherein the ceramic tiles have at least one surface color, and wherein at least one decorative grout has a color that is different from at least one surface color of the tiles. The tiles may be manufactured to have more than one color of decorative grout used in filling the openings, or more than one pattern of opening in the tiles. In the manufacture, the openings in instances of the same pattern may be filled with grouts of the same colors in the same locations, or different colors may be used in given pattern elements of tiles of the same pattern. (A luminescent, phosphorescent or sparkling effect in grout is considered a “color” for the purposes of this invention.)

In another aspect, the invention provides a method for reducing the amount of inventory required to supply a decorative tile installation service, the method comprising providing a selection of tiles having a glazed surface selected from a relatively small set of colors; providing a selection of patterns of openings in the surfaces of some tiles of the selected colors; and providing a selection of colored grouts; whereby a large number of unique installations can be created by combining various colors of grout for filling particular combinations of patterns. In the method, selected grouts are applied to selected patterns of tile openings during manufacture, allowing the customer the convenience of selecting any number of colors of grout within the decorative pattern of the tile, but only requiring the installer to use a single finishing grout during the actual installation.

In another aspect, the invention comprises an improved method for selling custom ceramic tile installations, the method comprising selections of tile patterns and decorative and bedding grouts which brought to a customer site to allow matching of colors to surroundings, and in which further customization is provided by the selection of decorative grouting to be placed in openings in the surfaces of at least one of the ceramic tiles in the installation. The selections may be physically brought to the customer site, or may be brought to the customer site in as images in printed or electronic form.

In an aspect of the invention, at least some part of the openings in the glazed front surface, which are filled with the decorative grout, may not penetrate through to the back surface of the tile.

In an aspect of the invention, at least one decorative grout glows in the dark, which may be due to phosphorescence; or emits luminescent visible light by the action of electromagnetism or by chemical means. The decorative grout may be highly reflective.

In one aspect of the invention, a decorative pattern is created by cutting a pattern into a tile with a water jet, and optionally preserving the piece cut out of the tile as an insert. In one embodiment, the insert may be cemented into a tile of the same pattern (but not necessarily the same color) by a grout, which is preferably decorative, for example by being colored, reflective, luminescent and/or phosphorescent.

In another embodiment, the glazed face of an insert is abraded away sufficiently that when the insert is inserted into a tile, and adhered therein by a grout which is not necessarily decorative, a depression is created in the front face of the tile which can be filled by a decorative grout. These applications of grout are preferably performed during manufacture, and a single application of grout may be used to fill the depression and provide grout to adhere said insert in place.

The decorative grouting of the invention can be decorative by virtue of being one or more of colored, reflective, luminescent and phosphorescent. More than one of these decorative modalities can be employed in an installation, and even within a single tile. As noted, all of these may be referred to herein as “colors” of grout, except as otherwise specified. Grouts emitting different colors of phosphorescence or luminescence can be combined in an installation.

In another aspect of the invention, a decorative tile with a phosphorescent or luminescent grout can serve an indicative function as well as a decorative function.

### BRIEF DESCRIPTION OF THE FIGURES

FIG. 1 is an oblique three dimensional representation of a tile of the invention.

FIG. 2 is a face view of a tile of the invention, having an opening filled with a decorative grout and finished typically later with a finishing grout.

FIG. 3 is a face view of an installation having three tiles, in a common bedding grout and with optionally different decorative grouts.

FIG. 4 shows a cross section of a tile having regions of an opening in the front face that that penetrate the thickness of the tile, together with regions that do not penetrate the thickness.

FIG. 5 shows the cross section of FIG. 4 with added texture to promote adhesion of grout to the surface.

FIG. 6 is a face view of the tile of FIG. 4 set in a finishing grout.

FIG. 7 shows an improved method of filling a hole in a tile with grout, in which a barrier is adhered across the face of the tile, temporarily closing the through-hole.

FIG. 8 shows an insert held in a tile by grout.

### DETAILED DESCRIPTION OF THE INVENTION

### Definitions

Grouts. A grout is a material having a consistency suitable for holding a tile in place during its installation. If used only for that purpose, such a grout is called a bedding grout herein. In conventional practice, grout is also used to fill in spaces between tiles, and grout used for such a purpose is called finishing grout herein. Finishing grout may optionally be colored, in the broad sense of “color” as used herein. Decorative grout is a groutlike material, normally colored, placed into decorative openings made in tiles to provide color in an installation of tiles.

The terms phosphoresecence, fluorescence, luminescence and luminous are used herein as described above. Cutting methods have been listed above and are conventional. Water jet cutting is presently preferred. “Tile” as used herein includes conventional ceramic tile, porcelain-based tile-like shapes, and natural or artificial stone, unless otherwise stated. Tiles have a face side and a back side, where the face side is meant to be exposed, and is often glazed. An “indicative” function of an installed decoratively grouted tile of the invention conveys information, in addition to being decorative.

In this invention, a decorative pattern is provided in a tile, or a set of tiles, in the form of one or more openings in the face of the tile, which openings continue at least in part to the back of the tile. The openings can be made in any convenient manner. The face of the tile is typically glazed to have a particular color (or mixture of colors) by conventional methods, and fired. Also provided are one or more decorative grouts, preferably selected to have one or more colors different from the color of the fired glaze on the front of the tile. The decorative grout is selected to achieve a desired visual effect. The openings, or through holes, are created in a tile in decorative patterns preferably by cutting with a water jet, but other methods of forming openings through ceramic tiles or similar tiles are potentially useful in the invention. The color of the grout is seen as a decorative pattern in the surface of the tiles, and often also contrasts with the finishing grout that fills in any space between the tiles.

One decorative effect, of particular interest in outdoor pools and in certain interior spaces, such as bathrooms, can be achieved by filling all or part of a decorative pattern in a tile with a luminescent or phosphorescent grout. An unspecified form of luminescence is displayed by certain resin-based grouts, for example by an epoxy-based grout called “Laticrete SpectraLock Glow”, available from Laticrete International, 1Laticrete Park, North Bethany, Conn., and which is described, for example, in U.S. Pat. No. 6,881,768. According to its Material Safety Data Sheet, this epoxy-based grout contains a “luminescent” pigment, comprising a “europium doped alkaline earth metal aluminate oxide.” On observation, after exposure of the materials to daylight or incandescent light, at least some light is emitted from these materials as phosphorescence, as defined above. Other stable luminescent materials could also be suitable in this application. It is likely that such materials could be used with a non-organic binder, such as a conventional (non-polymeric, cementitious) grout, or in a polymer that is cured by any conventional means.

In an alternative embodiment, a grout, such as the epoxy grouts described, or a conventional inorganic grout, can be made highly reflective by admixture with glass spheres, or other reflective materials. This can be done alone or in combination with a luminescent material or a colored material, and in an organic or inorganic grouting material. In the description below, grouting materials exhibiting optical effects such as luminescence, phosphorescence or reflectivity are treated as being a grout of a certain “color”, and so a decorative grout of a given color (in the ordinary sense) which also contains an optical effect material is considered to be of a different color than its parent colored material.

In conventional tile installation practice, particularly for walls, one or typically two layers of cementitious material, such as mortar, are applied at the site and allowed to cure. Then a thin layer of a grouting material is applied, such as a conventional bedding grout (typically a thin set mortar), or a polymer-based adhesive material of similar functionality (also called a grout herein), and the tile is set into this layer of bedding grout. Spacers may be used to control the separation between tiles. A finishing grout, which may be the same as or different from the bedding grout used to attach the tiles to the wall or other surface, is conventionally applied to fill the space between tiles, and excess grout is washed or wiped off the face of the tile. Grout, whether cementitious or polymeric, is normally made so that it adheres well to unglazed and textured surfaces, such as the sides and back of glazed ceramic tiles (the latter of which are typically ribbed), and poorly to glazed surfaces, at least prior to curing, so that it can easily be washed off the decorative surfaces except where needed.

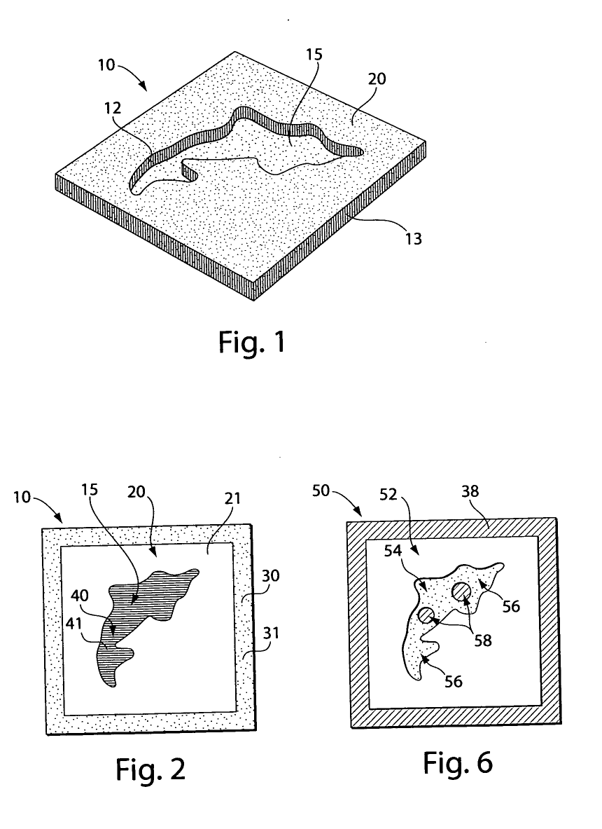

FIG. 1 shows a perspective view of a ceramic tile 10 with an opening 15 in the tile, having a decorative shape. The opening 15 extends, in this embodiment, from the glazed front face 20 of the tile 10 through the tile to the back (not shown). The inner edge 12 of the opening 15 is generally perpendicular to the tile face 20 and parallel to the tile edge 13, but may be slightly slanted to facilitate insertion of grout into the opening 15, or may instead diverge slightly so that the area on the rear face is greater than that on the front face, to promote retention of the decorative grout in the tile.

FIG. 2 shows the tile 10, having a surface color 21 on its glazed face 20, and an opening 15. Tile 10 is laid in a bedding grout (not shown) and sealed at the edges by a finishing grout 30 having a finishing grout color 31, which may be the same as but is typically different from the surface color 21 of the tile face 20. A first decorative grout 40, having a first decorative grout color 41, which may the same as or different from the first grout color 31 of the finishing grout 30, and which is typically a different color than the color 21 of the surface 20 of the tile 10, is applied to fill the opening 15, typically during manufacture. In any case, any excess finishing grout is wiped off of glazed surfaces and surfaces pre-grouted with a decorative grout before it dries, as is conventional in the art. Care will be exercised to prevent mixing of various grouts during installation. The tiles may have a single opening per tile (as illustrated) or there may be several openings in a given tile. When multiple openings are present on a tile, they optionally can be filled with more than one color of decorative grout.

The bedding grout is not shown because in most cases the bedding grout will typically be covered by the finishing grout 30 which will fill the spaces between the tiles. Typically, the bedding grout will not have a color, because it is not seen (and color additives cost extra), while the finishing grout 30, used in smaller amounts, is frequently colored to give a specific effect.

FIG. 3 shows a set of three related decorative tiles 22, 24 and 26, having tile surface colors 23, 25, 27 on their glazed surfaces, wherein said surface tile colors may be the same or different. The tiles are finished at the edges with a finishing grout 30 having a first grout color 31. The tiles have openings 16, 17, 18 in their glazed surfaces. The shapes of the openings 16, 17, 18 may be the same (as illustrated) or different, and may be a single opening per tile (as illustrated) or there may be several openings in a given tile. Second, third and fourth decorative grouts 42, 44 and 46, having colors 43, 45, 47 that are typically different from the background colors 23, 25, 27 of the faces of the tile or tiles to which it is applied, is applied in openings 16, 17, 18. This is preferably done during the manufacturing of the decorative tiles, for simplicity of installation and to minimize cross-contamination of grouts in the field. The four grout colors 31, 43, 45, 47 may be the same or different. Each grout 42, 44, 46 and optionally 30 may further contain other decorative elements besides pigment-based color. In one embodiment the decorative element may be a luminescent or preferably a phosphorescent material. In another embodiment, the decorative element may be a highly reflective material.

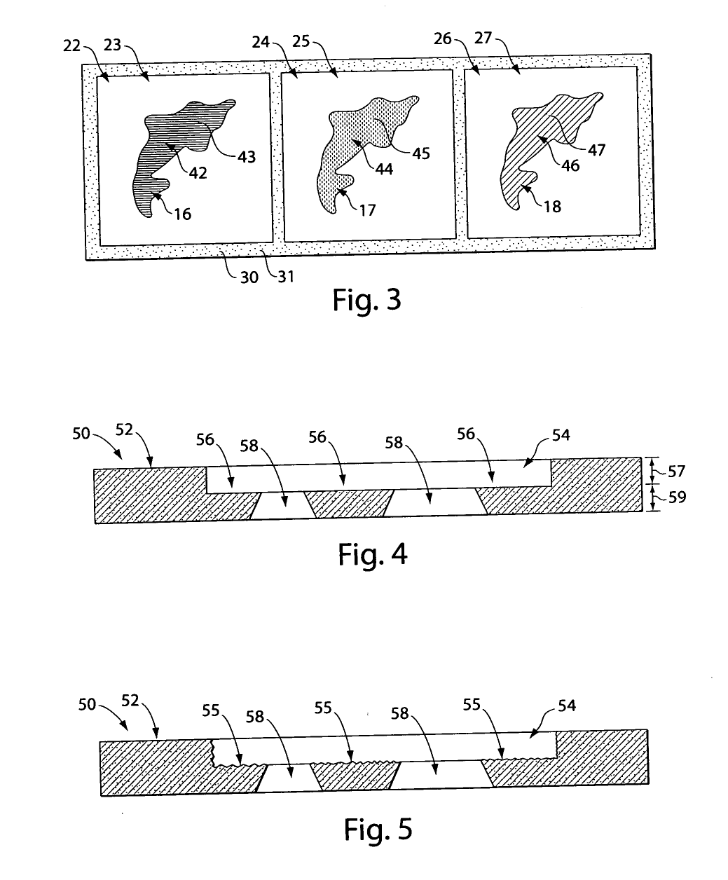

FIG. 4 shows in cross section a tile 50 with a front face 52 having an opening 54, in which no decorative grout is yet present. The opening 54 has regions 56 in which the opening partially penetrates through the tile, and other regions 58 in which the openings penetrate the tile completely. Typically the thickness of the partial penetrations will be a first value 57, and the through holes 58 will have an additional thickness 59. To insure coherence of the applied decorative grouting, the thickness 57 is preferably a significant fraction of the thickness 59, for example at least about ¼ of the thickness of 59, ranging up to a thickness about the same as the thickness 59. The full openings 58 may optionally be tapered as shown (although typically less dramatically), so that after curing, the decorative grout cannot pull out of the opening solely because its adhesion to the tile weakens with age or use.

FIG. 5 shows the cross section of a tile 50, as in FIG. 4, with a rugged, texturized, high-area bottom surface 55 of the opening 54. The roughness of the bottom is exaggerated in this drawing compared to production tiles, to emphasize that the bottom of the opening is preferably not smooth, but is optimized for grout adherence.

FIG. 6 shows a front view of the tile 50 of FIG. 4, with front face 52, set in a bedding grout 38, in which no decorative grout is present in the opening 54. The opening 54 has regions 56 of partial penetration and regions 58 of complete penetration. Typically, a decorative grout will be installed into the openings 54, 58 before the tile 50 is mounted in a bedding grout; but this particular conformation is also suitable for filling with decorative grout subsequent to installation, since troweling, taping and cleaning can at least potentially fill the entire opening with decorative grout.

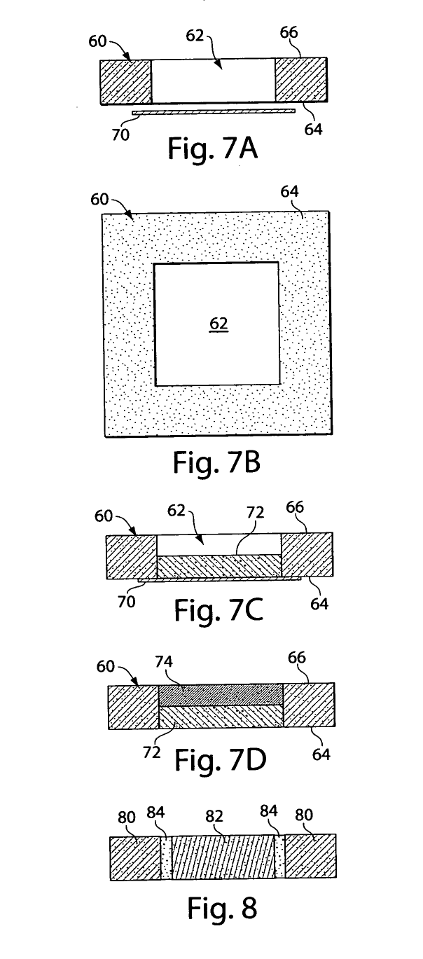

FIG. 7 shows a preferred method of filling a hole in a tile with a decorative grout. A tile 60 with a through hole 62 penetrating from its face 64 to its back 66 is shown in cross section (FIG. 7A), and in face view (FIG. 7B; film not shown.) An adherent film or plate 70 (shown in FIG. 7a but not in FIG. 7b) is adhered across the hole on the glazed face side 64 of tile 60. In FIG. 7C, the tile 60 carrying film 70 is placed face-down on a supporting surface (not illustrated), and then the hole 62 is partially filled with a decorative grout 72. After the decorative grout 72 has at least partially cured, additional grout 74 (the same as decorative grout 72, or different) is applied to fill the hole, as shown in FIG. 7d. This may be done during installation, or preferably beforehand. At any time after sufficient setting of the decorative grout 72, the adherent film 70 is removed. Preferably, the attachment force is selected so that film 70 is readily peeled from the surface, and so that the attaching resin or the like is removed along with the film, rather than remaining on the tile face or the grout. This method produces a superior surface smoothness for the cured decorative grout section of the tile face, and is presently preferred.

The individual tiles may have more than one opening (not illustrated), and the “images” (shapes of openings) in the tiles in a set of tiles are not necessarily all the same. Collectively, the number of openings and their shape and relative orientation can be called the “pattern” of a tile. Manufacture can be performed with a single pattern of tile (as shown in FIG. 3), optionally with more than one color of decorative grout. Alternatively, an installation can have several or many different tile patterns.

Likewise, a simple installation can have only one color of decorative grout filling the openings in the tiles. Alternatively, as shown in FIG. 3, different colors of decorative grout can be used on different tiles. Typically during manufacture, more than one color of grout can be applied to a particular tile, if it has one opening or more openings, and this can be repeated identically on other tiles of the same pattern, or can be varied. For larger installations, such as kitchens, bathrooms and swimming pools, complex patterns and color effects can be achieved with a limited number of tile patterns.

The patterns of openings in the tiles are made by any conventional means. A conventional method is the casting of the green body form of the tile in a mold, and after drying the green body, firing it to bisque, and preferably applying a glaze-forming material to the front face of the bisque body, firing it, to produce a tile having one or more openings in a front glazed surface, optionally fully extending to an unglazed back surface. Casting can also provide tiles with openings in the front surface, but not extending through to the back of the tile, or only partially extending to the back of the tile, as shown in FIGS. 4-6. Selection of partial and complete passage through the tile can provide a combination of structural strength with adherence of the decorative grout or grouts to the bedding grout. Alternatively, patterns can be cut into partially dried green bodies with a die or the like.

Other methods of forming holes in tiles, besides casting, molding and die-cutting of greenware, include laser cutting, water jet cutting, and machining, either of green ware or of fired tiles. In another mode, openings can be created by the provision of sacrificial elements that burn away during firing. Some of these techniques are described in more detail in JP1316260, cited above, and in U.S. Pat. No. 5,057,258 to Scuri, EP0936325 to Estudio, and JP11129236 and JP11129234 to Kazuyuki. Water jet cutting of fully fired tiles has been found to be simple and effective, and is presently preferred.

Some of these techniques, including water jet cutting and some versions of laser cutting, ablate a fine line of the material of the tile, extending through the tile. This process leaves a substantial piece intact, separated from the rest of the tile by one or more millimeters of space. This piece, referred to herein as an “insert”, can be glued back into a tile cut to the same pattern (and not necessarily of the same face color) with a decorative grout. It also can be abraded at the glazed face so that when it is adhered to a tile of similar pattern, for example by a grout which may be decorative or not, then an opening in the face of the tile is created that can be filled with a decorative grout. There can be more than one insert per tile, and the inserts may be handled differently (e.g., some abraded and some not.)

FIG. 8 shows a tile 80 with an insert 82 retained in a hole in tile 80 by a decorative grout 84. The insert may be the piece that was removed from the tile to make the hole, for example by a water jet. A thin but relatively uniform layer of tile material surrounding the insert 82, which is entirely missing due to the action of the jet, is filled with the decorative grout 84, so that the decorative grout can create a subtle outlining of the insert 82.

In the manufacture of tiles for use in the invention with through holes, it is preferable to leave a coarse texture on the back face of the tiles, optionally in the form of grooves, ridges and the like, to promote adhesion of tiles to the bedding grout. Such texture is preferably also used on the bottom surface of an opening wherever the opening is of partial thickness. When through holes are present, provision can be made for penetration of the bedding grout partially into through holes, to ensure adhesive coupling to the bedding layer of grout. Alternatively, whatever material is used to completely fill the back or the through-hole can be contacted with a shaping device to provide increased surface area at the back of the filled through hole.

Installations of the tiles and patterns of the invention can be made in any conventional location where tile is used. Particular uses include waterline tile or other tile in swimming pools; wall or counter tiling in kitchens, bathrooms and other conventionally or potentially tiled locations; and wall tile in general. The system of the invention can also be used in tiling floors, with attention to the possibly coarser finish and lesser durability of grouting, compared to conventional fired glazed ceramic tile.

The provision of tiles with patterns of decorative grout in openings allows a simple method of customizing an installation of tile, for example of water line tile in a swimming pool, by providing a selection of ceramic tiles with various patterns of decorative openings and offering choices of colored decorative grouts and of finishing grout; and installing the tiles on the wall of the pool, allowing filling of the decorative openings in the tiles with various colors of decorative grout before installing the tiles, and optionally filling between tiles with a selected finishing grout, which may be decoratively colored, or not. The same technique can be used to customize any installation of ceramic tile in a house or other structure, on surfaces including, among others, an interior or exterior wall, a floor, a counter, a stair or step, an indoor pool or spa, a sauna, a bathtub, and a shower.

Customized tiles can be accommodated readily in this system. A design can be made to order, used to drive a cutting device, and the tiles can be filled at a factory with decorative grout, and delivered ready for installation at a site. This will especially be a preferred mode with single color installations, such as phosphorescent patterns in tiles.

Moreover, the provision of tiles with patterns of openings, and of colored, light-emitting, reflective, or other decorative grouting, allows a major reduction of inventory in a business that creates custom tile installations. Having only one or a few background tile colors, which may be neutral backgrounds such as white, sand, black, dark green and blue, together with perhaps a dozen or more colors of grout, and twenty to perhaps a few hundred tile patterns, allows a company to have a small inventory and yet be able to quickly produce unique tile installations, optionally designed by or with the customer, without greatly increasing the cost of the installation. This permits a novel method of doing business, in which tile and grout is brought to the customer's site for selection, as is now possible with rugs, drapes and other decorative elements of a building, and then customized color suites are created in short order at a factory.

The light emission of luminous or phosphorescent grout in tile is brightest in large area designs, such as those of FIG. 1. However, they may also be used in finer-featured designs, such as those described above involving grooves, or as grout used to re-adhere an insert into a tile. In any of these, use of depressed but flat areas, grooves, etc., preferably with through holes as shown in FIGS. 4 and 5, is also useful and desirable to maintain strength.

Moreover, the phosphorescent tiles of the invention can serve not only decorative purposes, but can also serve indicative purposes as well. Passive self-illuminated devices can provide indicative (informative) functions such as warnings or locational or directional clues in dark environments. (Some uses for such illumination methods are described in the art, although not for combined use as a decorative element, as in the present invention; for example, U.S. Pat. Nos. 6,207,077; 7,297,964; 5,961,072; and 6,307,207.) In one aspect phosphorescent materials, that gather light from natural and artificial sources, and release the light as luminescence that is visible in the dark, are employed to create decorative patterns which illuminate a location. The devices optionally display warning or directional indicators, or location indicators (room number, house number, etc.). The devices do not require a grid connection or batteries, and are thus inexpensive to install and operate, and suitable for a variety of uses. Uses can be in residential or non-residential sites, and include general low-light illumination, exit indicia, location indicia (such as room or building numbers), and the like. When made by the use of colored or phosphorescent tiles, such indicators are also decorative in the environment of the installation.

The emission of light from decorative grout by a phosphorescent mechanism has been demonstrated, and is a simple, practical and preferred means for achieving tiles that glow in the dark. However, the use of other chemical or physical means to achieve light emission is possible, and is an aspect of the invention. Such other means include reaction of minerals or other stable catalysts in the grout with added chemicals, such as chlorine in the pool water, or the stimulation of phosphors or other materials embedded in tiles by electric or magnetic fields to achieve the same effect.

### EXAMPLE 1

### Method for Making a Glowing Tile

Mix a commercial phosphorescent inorganic material into a suitable polymerizable mixture, such as epoxy resin, which will constitute the continuous phase of the resin both before and after polymerization. Exemplary mass ratio: about 200 resin: 1 phosphor. A design was cut in a glazed tile with a water-jet cutter. The cut-out portion (“insert) was saved. A phosphorescing material “DAZZLE GLOW” from Laticrete was mixed with an epoxy resin (also from Laticrete) at a weight ratio of 1 parts phosphor to 2 parts epoxy resin. The resin/phosphor mixture was then mixed with 2 parts by weight, based on the resin weight, of curing agent (hardener), provided with the kit by Laticrete of Bethany, Conn. The polymerizing phosphorescent material was used to glue the removed portions (inserts) back into the original tile, or a duplicate.

Excess adhesive was wiped off, and the adhesive was allowed to completely set, and was trimmed and cleaned as required. The result is a region in the tile, surrounding the insert (and so having a decorative pattern), that absorbs daylight or incandescent or fluorescent light, and re-emits the energy as phosphorescence at night.

This is a simple, efficient way to make a phosphorescent ceramic tile. If two or more holes are made in a tile, different phosphors can be used to make a multicolor glow. Many designs can be placed into tiles of a relatively small set of background colors (for example 10 to 40), and produced quickly as to design, color and background by custom order. Because only the shape of the design and the color effects will be highly variable, customers can see the actual effect of their choices without the dealer having to maintain stock of every pattern/color/phosphor combination.

### EXAMPLE 2

### Phosphorescent Pattern

Ceramic tiles, 6×6 inches (150×150 mm) in area and about 5 mm thick, with a dark blue glazed face, were cut with a waterjet to create an opening in the shape of a dolphin, about 6 inches along the diagonal, in each tile. The face of each tile was covered with a sheet of adhesive tape (e.g., 3M 371 Scotch Clear Packaging Tape, or other). The taped tile was placed face down on a workbench.

A two part chemically-curing epoxy resin was obtained from Laticrete of Bethany, Conn. A phosphorescing material “DAZZLE GLOW” from Laticrete was mixed with the resin at a weight ratio of 1 parts phosphor to 2 parts epoxy resin. The resin/phosphor mixture was then mixed with 2 parts by weight, based on the resin weight, of curing agent (hardener), provided with the kit, to provide a setting time of about 20 minutes. Aliquots of the resin/phosphor/curing agent were then dispensed into the back of the dolphin pattern in the adhesive-sealed tiles, sufficient to fill the opening to be flush with the back of the tile. The mixture was lightly cured after about 5 minutes, and was left to finish curing for at least 60 min before removing the adhesive tape from the front face of the tile. In an alternative method, about 10 ml of the activated phosphor-containing resin was placed in the hole in the tile. After curing for about 10 minutes, the remaining volume in the back of the pattern was filled with white sand and the same epoxy resin, without phosphor. After at least 40 minutes more, the tape could be removed from the face of the tiles. The decorative grout at the surface is smooth and flush with the face of said tile.

### EXAMPLE 3

It was found that the formation of bubbles of gas in the resin composition can damage the surface finish of the decorative grout during the curing process. It was found that heating the epoxy with an IR lamp or by other method, after depositing the mixture in the opening in the tile, will cause the bubbles to migrate to the back side of the decorative resin layer, giving a good surface finish.

### EXAMPLE 4

The decorative layer applied to the tape of the face down tile, as in Example 2, can be backfilled with a conventional UV cure epoxy while the decorative layer is in a mid cure state. For example, when that layer is partially cured, a second mixture for support fill is added, consisting of 1 part SpectraLock resin, 1 part SpectraLock hardener, and 1 part Spectralock Sand. Alternatively, we can support the phosphorescent front layer by filling the back with Dymax UV Gasket epoxy. Other epoxies, for example from Merkrete or Durabond, can be used as well. This process causes the back filler to cure immediately upon introduction of a UV lamp operation and also may hasten curing of the water proof decorative layer that is flush with the glazed surface.

Unless defined otherwise, all technical and scientific terms used herein have the same meanings as commonly understood by one of skill in the art to which the disclosed invention belongs. Although any methods and materials similar or equivalent to those described herein can be used in the practice or testing of the present invention, the preferred methods, devices, and materials are as described. Publications cited herein and the material for which they are cited are specifically incorporated by reference, where such incorporation is permitted. Those skilled in the art will recognize, or be able to ascertain using no more than routine experimentation, many equivalents to the specific embodiments of the invention described herein. Such equivalents are intended to be encompassed by the following claims.

1. A decorative luminous ceramic tile, having a decorative design formed as one or more holes in said ceramic tile, wherein said holes are filed at least in part with a decorative luminescent or phosphorescent grout-like material during manufacture.

2. The decorative luminous ceramic tile of claim 1 wherein one or more of said holes is a through hole connected both to the face and to the back of said tile.

3. The decorative luminous ceramic tile of claim 2, wherein the grout in said decorative holes extending through the tile is smooth and flush with the face of said tile.

4. The decorative luminous ceramic tile of claim 1 further comprising an insert affixed within at least one hole by a decorative grout that is visible at the face of the tile between said insert and the face of said tile.

5. The decorative luminous ceramic tile of claim 1 wherein said decorative design further provides an informative function.

6. The decorative luminous ceramic tile of claim 1 in which said grout like material is phosphorescent.

7. The decorative luminous ceramic tile of claim 1 in which the grout-like material comprises a polymeric resin.

8. A method of making a decorative luminous ceramic tile, comprising the steps of making a ceramic tile; providing holes in said tile; and filling said holes at least in part with a decorative phosphorescent grout.

9. The method of claim 8 wherein one or more of said holes is a through hole connected both to the face and to the back of said tile.

10. The method of claim 8 wherein during said filling step, said holes are reversibly blocked on the face of the tile, and the decorative phosphorescent grout is added from the back of the tile.

11. The method of claim 8 further comprising a step in which an insert is affixed within at least one hole by a decorative phosphorescent grout that is visible at the face of the tile between said insert and the face of said tile.

12. The method of claim 8 wherein the decorative phosphorescent grout comprises polymeric resin.

13. The method of claim 8 wherein the decorative openings in the tile are made by one or more processes selected from casting, molding, die-cutting of greenware, water-jet cutting, laser cutting, machining, and provision of sacrificial elements that burn away during firing.

14. A method of forming a decorative tile installation, comprising the steps of:
a) providing one or more tiles, each tile having a surface color, and each tile having at least one decorative opening formed therein;
b) filling each opening in each tile with a decorative grout, wherein at least one opening is filled with a decorative grout having a color that is different from the surface color of said tile;
c) providing a bedding grout, having a color which may be the same as or different from the tile surface color;
d) affixing said tiles to the bedding grout; and
e) filling spaces between tiles with a finishing grout, the color of which may be the same as or different from the color of said decorative grout.

15. An installation of decorative tiles, wherein said decorative tiles have been formed by applying one or more decorative grouts to fill openings in glazed ceramic tiles before affixing the ceramic tiles to a bedding grout layer,
wherein the ceramic tiles have at least one surface color,
and wherein at least one decorative grout has a color that is different from at least one surface color of the tiles;
wherein said tiles are installed in a prearranged pattern in a bedding grout layer; and
wherein the installation further comprises a finishing grout, which is applied to fill in spaces between decorative tiles in the installation after they are installed in said bedding grout layer.

16. The installation of claim 15 wherein said decorative grout is phosphorescent.

17. The installation of claim 15 wherein the holes in said tile are through holes, and the decorative grout is applied into said through holes in said tile from the back of said tile while the face of said tile is reversibly sealed, and is cured in situ to form affix said decorative grout within said tile.

18. The installation of wherein the decorative grout further has an indicative function.

19. A tile comprising a flat ceramic plate, said plate having a face and a back, said face having one or more through holes, said through holes forming a decorative pattern; and one or more decorative grouts installed and cured in said through holes, and wherein the face surface of said decorative grout comprises a phosphorescent material.

20. The tile of claim 19 wherein said decorative grout further comprises one or more fluorescent or luminescent materials.
